(19) United States
(12) Patent Application Publication
(10) Pub. No.: US 2004/0055218 A1
(43) Pub. Date: Mar. 25, 2004

(54) Safety window

(76) Inventors: Isaac Forsyth, Lochans,Stranraer (GB); Neil Forsyth, Lochans, Stranraer (GB)

Correspondence Address: TESTA, HURWITZ & THIBEAULT, LLP, HIGH STREET TOWER, 125 HIGH STREET, BOSTON, MA, 02110, US

(21) Appl. No.: 10/398,852

(22) PCT Filed: Oct. 3, 2001
(86) PCT No.: PCT/GB01/04385

(30) Foreign Application Priority Data
Oct. 10, 2000 (GB) 0024783.3

(51) Int. Cl. E06B 7/00

(52) U.S. Cl. 49/54; 49/50; 49/70

(57) ABSTRACT

A safety window comprising a frame unit and central cartridge, on which are mounted security bars, is employed to provide an easy exit route for an operator in the event of an emergency. The safety window is maintained in the closed position by spring biased locking bar mechanism. When required, the operator manually activates the locking bar mechanism so opening the window. This process results in the central cartridge and associated security bars to pivot through 180° so as to locate in an open position that is clear of the frame unit.

The present invention relates to the field of safety windows. In particular, it relates to a safety window that provides quick exit means in the event of an emergency.

The balance between security and personal safety is a common issue with regards to windows. On the one hand, an occupant of a building wishes to feel that they and their property are safe from intruders. Within such buildings, windows are often regarded as a weak point offering access opportunities to intruders and as such extra security locks and bars are often added to standard fittings.

On the other hand, the addition of these extra security features can have the result of barricading the occupants within a building. Therefore, in the event of an emergency when a quick exit from the building is required, such extra security measures can hinder and in the case of poorly designed systems deny occupants the opportunity of a quick exit.

It is an object of the present invention to provide a safety window that is secure to intruders but can be quickly and easily opened in the event of an emergency.

It is a further object of the present invention to provide a safety window that when moved to an open position locates the window clear of the window frame unit so providing an unobstructed exit route.

According to the present invention there is provided a safety window comprising a cartridge, a window frame and an external security means, wherein the external security means is attached directly to the cartridge such that access through the safety window is not impeded by the external security means.

Preferably the external security means comprises a plurality of bars. Alternatively, the external security means comprises a grill.

Preferably the safety window further comprises an alarm system comprising a smoke detection device, a light source and a mechanical movement detection device.

Most preferably the alarm system is powered by a dedicated power source. Preferably the dedicated power source is a battery.

Preferably the movement detection device is activated if the cartridge is pivotally opened by predetermined angle.

Most preferably the activation of a detection device results in the light being illuminated.

According to a second aspect of the present invention there is provided a window release mechanism for a cartridge mounted in a window frame comprising a locking bar, a locking bar bias means, a locking bar control means and a release handle, wherein the locking bar bias means provides a locating force to the locking bar causing it to interact with the cartridge so maintaining the cartridge in a closed position.

Most preferably activation of the release handle causes the locking bar control means to overcome the locating force of the locking bar bias means, wherein the locking bar is displaced clear of the cartridge resulting in the cartridge moving from the closed position to an open position.

Preferably the locking bar bias means comprises springs.

Most preferably the window release mechanism further comprises a bias means that acts to move the cartridge from the closed position to the open position.

Preferably the bias means comprises springs mounted in the window frame.

Preferably the locking bar, the locking bar bias means and the locking bar control means are located within the window frame.

Preferably the locking bar control means further comprises a lifting pivot, a lifting pivot bar, a pivot, a hinge and a control bar.

Preferably the locking bar is connected to the locking bar control means via the lifting pivot.

Preferably the release handle is connected to the locking bar control means via one end of the control bar.

Optionally the release handle comprises a securing pin and a securing pin mount wherein with the securing pin located within the securing pin mount the release handle can not be activated.

According to a second aspect of the present invention there is provided a sliding hinge mechanism for opening a cartridge mounted in a window frame comprising a two armed hinge a connecting arm and at least one sliding pivot, wherein the sliding pivot allows the connecting arm to move such that the axis about which the cartridge pivots open translates outside a plane as defined by the window frame.

Most preferably the sliding hinge mechanism causes the cartridge to pivotally open to a position where the cartridge lies outside a projected three dimensional volume as defined by the internal, two dimensional area of the window frame.

Preferably opposite ends of the connecting arm are connected to different arms of the two armed hinge via sliding pivots.

Embodiments of the present invention will now be described by way of example only with reference to the accompanying figures, in which:

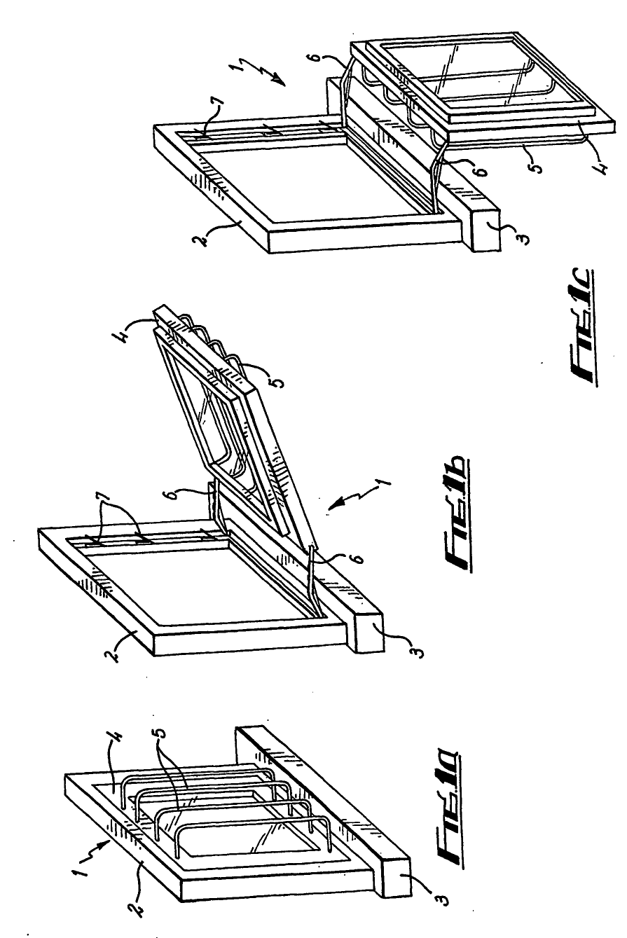

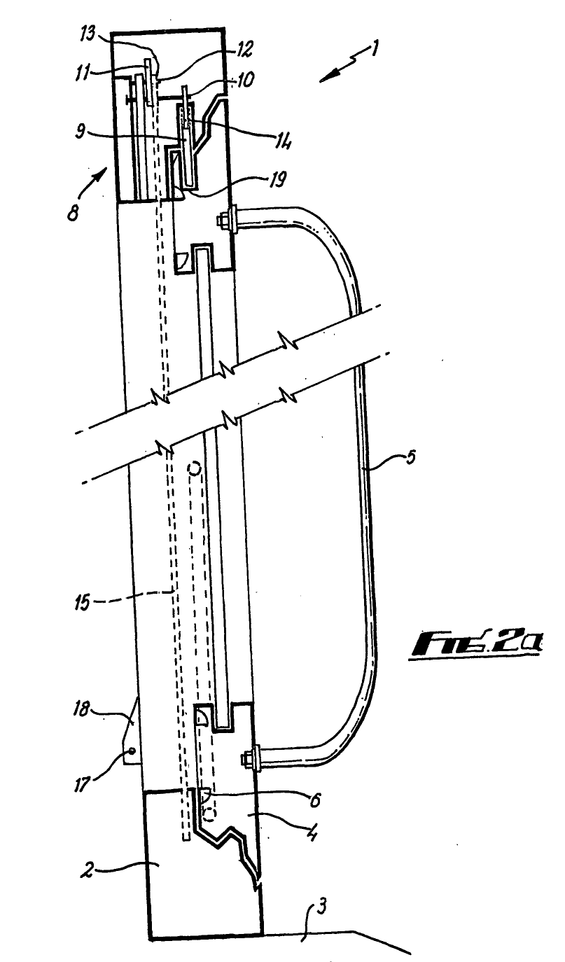

FIG. 1 illustrates a safety window in accordance with the present invention in:

a) a closed position;

b) an intermediate position;

c) an open position;

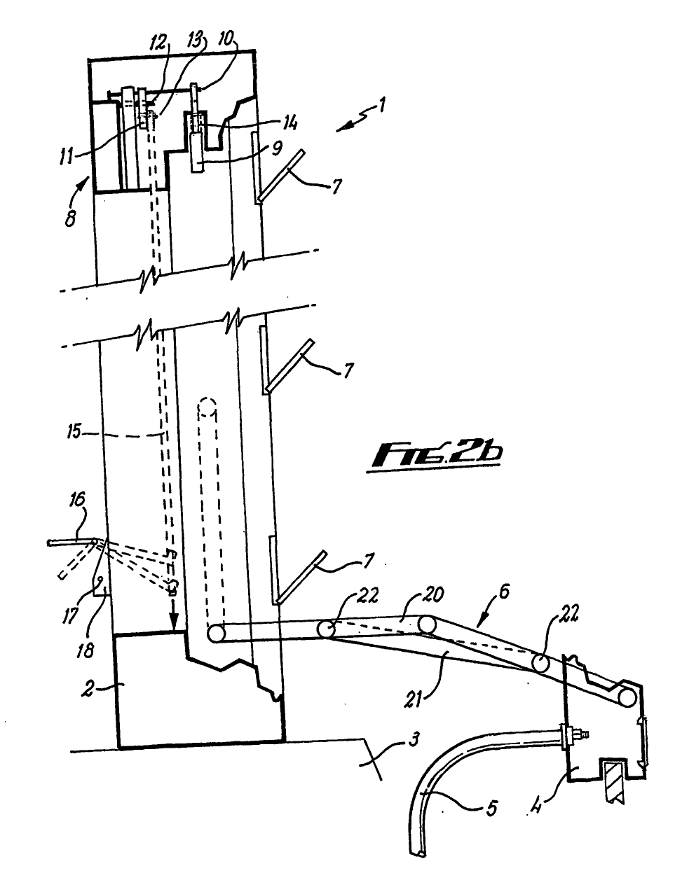

FIG. 2 illustrates a side cross-sectional profile of the safety window in:

a) the closed position;

b) the open position; and

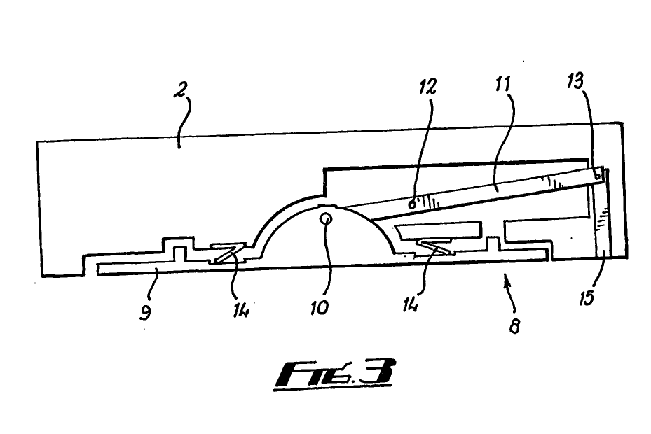

FIG. 3 illustrates a front cross-sectional profile of the release mechanism of the safety window of FIG. 1.

Referring to FIG. 1 a safety window 1 is generally depicted. The safety window can be seen to comprise a frame unit 2 mounted on a windowsill 3, a central cartridge 4, a series of security bars 5, two sliding hinge mechanisms 6 and a series of V-shaped springs 7.

The safety window 1 remains in the closed position of FIG. 1(a) due to the presence of a locking bar mechanism 8 mounted internally within the frame unit 2. Detail of the locking bar mechanism 8 is presented in FIG. 2. Here a side on cross-sectional profile of the safety window 1, in both the closed position and the open position, is presented, see FIGS. 2(a) and (b) respectively. Additional features of the locking bar mechanism 8 can be seen in FIG. 3 which presents a front cross-sectional profile of the top section of the frame unit 2.

The locking bar mechanism 8 can be seen to comprise a locking bar 9, a lifting pivot 10, a lifting pivot bar 11, a pivot 12, a hinge 13, two V-shaped springs 14, a control bar 15, a release handle 16, a securing pin 17 and a securing pin mount 18.

The safety window 1 is maintained in the closed position by the locking bar mechanism 8. The locking bar 9 locates within a machined groove 19 formed on the top edge of the central cartridge 4. The V-shaped springs 14 are attached to the frame unit 2 and act to maintain the locking bar 9 within the machine grove 19.

FIG. 2(b) also shows the component parts of the sliding hinge mechanism 6. The sliding hinge mechanism 6 comprises a two armed hinge 20 and a sliding connecting arm 21. Opposite ends of the sliding connecting arm 21 are connected to separate arms of the two armed hinge 20 via sliding pivots 22.

Employing the locking bar mechanism 8 allows the safety window 1 to be fully opened in the case of an emergency. An operator is required to free the release handle 16 by removing the security pin 17 from the security pin mount 18. This frees the release handle 16 to an accessible position for the operator. Manually pulling the release handle 16 upwards results in the control bar 13 being pulled downwards, which in turn acts upon the lifting pivot bar 11 by means of the hinge 13. Thus, the lifting pivot bar 11 is raised by the pivotal action of the control bar 15 resulting in the locking bar 9 overcoming the bias force of the V-springs 14 so freeing itself from the machine groove 19.

The V-shaped springs 7 located in the side of the frame unit 2 then assists in pushing the central cartridge 4 away from the frame unit 2. Employment of the sliding hinge mechanisms 6 allow the central cartridge 4 to pivot clear of the windowsill 3. As the safety window 1 opens the axis about which the central cartridge 4 pivots translates horizontally away from the frame unit 2. This results in the central cartridge 4 to translating past the windowsill 3 such that it can pivot through 180°. This ensures that the safety window 1 fully opens to provide an unobstructed escape route for the operator. Additionally the open position of the safety window 1 allows for the positioning of ladders by a third party so as to aid in the speedy evacuation of occupants of the building.

After the emergency situation is over, the central cartridge 4 may then be re-secured in the closed position by simply swinging it about the sliding hinge mechanisms 6 back into the original position.

The safety window can be adapted to incorporate an alarm system (not shown). Such a system may comprise a smoke detection device, a light, an audible alarm and a movement detection device.

The smoke detection device would be activated in the event of a fire, sounding an audible alarm while simultaneously causing the light to be illuminated. This offers the significant advantage of indicating to an operator a point of exit in an emergency, thus reducing evacuation times.

Similarly, in the event of the window being opened by a predetermined amount, either by an internal operator or by an external intruder, the mechanical detection device would again cause the audible alarm to sound and the light to be illuminated. This would have the obvious advantage of highlighting the attempted point of entry by an intruder.

The present invention has the advantage that it is versatile thus allowing it to be installed throughout a building so as to provide a variety of escape routes. Such escape routes would thus ensure that in the event of the need for evacuation all occupants have access to quick and easy escape routes.

The present invention has the further advantage that the central cartridge 4 is designed to be a flush fitting with the frame unit 2 without any appreciable gap between it and the frame. This provides a useful security feature in that there is no access for a would be intruder to insert an implement to prise the frame unit 2 and central cartridge 4 apart.

Additional security is achieved by the addition of the external security bars 5 to the outside of the central cartridge 4. The employment of the sliding hinge mechanisms 6 still permits the central cartridge 4 to fully rotate through 180° so providing the required unobstructed escape routes for the operator.

It is anticipated that the glazed frame may be a single or double glazed unit as desired and may also be fitted with a patterned, opaque or armoured glass. A blank plate could also be used as a viable alternative to a glass pane within the central cartridge 4.

Further modifications and improvements may be incorporated without departing from the scope of the invention herein intended.

1) A safety window comprising a cartridge, a window frame and an external security means, wherein the external security means is attached directly to the cartridge such that access through the safety window is not impeded by the external security means:

2) A safety window as claimed in claim 1 wherein the external security means comprises a plurality of bars.

3) A safety window as claimed in claim 1 wherein the external security means comprises a grill.

4) A safety window as claimed in any of the preceding claims wherein the safety window further comprises an alarm system comprising a smoke detection device, a light source, an audible alarm and a mechanical movement detection device.

5) A safety window as claimed in any of the preceding claims wherein the alarm system is powered by a dedicated power source.

6) A safety window as claimed in 5 wherein the dedicated power source comprises a battery.

7) A safety window as claimed in any of the preceding claims wherein the movement detection device is activated when the cartridge pivotally rotates through a predetermined angle.

8) A safety window as claimed in any of the preceding claims wherein the activation of a detection device results in the light being illuminated.

9) A safety window as claimed in any of the preceding claims wherein the activation of a detection device results in the audible alarm being sounded.

10) A window release mechanism for a cartridge mounted in a window frame comprising a locking bar, a locking bar bias means a locking bar control means and a release handle, wherein the locking bar bias means provides a locating force to the locking bar causing it to interact with the cartridge so maintaining the cartridge in a closed position.

11) A window release mechanism as claimed in claim 10 wherein activation of the release handle causes the locking bar control means to overcome the locating force of the locking bar bias means such that the locking bar is displaced clear of the cartridge, resulting in the cartridge moving from the closed position to an open position.

12) A window release mechanism as claimed in claim 10 or claim 11 wherein the locking bar bias means comprises springs.

13) A window release mechanism as claimed in any of claims 10 to 12 further comprising a bias means that acts to move the cartridge from the closed position to the open position.

14) A window release mechanism as claimed in claim 13 wherein the bias means comprises springs mounted in the window frame.

15) A window release mechanism as claimed in any of claims 10 to 14 wherein the locking bar, the locking bar bias means and the locking bar control means are located within the window frame.

16) A window release mechanism as claimed in any of claims 10 to 15 wherein the locking bar control means further comprises a lifting pivot, a lifting pivot bar, a pivot, a hinge and a control bar.

17) A window release mechanism as claimed in any of claims 10 to 16 wherein the locking bar is connected to the locking bar control means via the lifting pivot.

18) A window release mechanism as claimed in any of claims 10 to 17 wherein the release handle is connected to the locking bar control means via one end of the control bar.

19) A window release mechanism as claimed in any of claims 10 to 18 wherein the release handle comprises a securing pin and a securing pin mount such that with the securing pin located within the securing pin mount the release handle can not be activated.

20) A sliding hinge mechanism for opening a cartridge mounted in a window frame comprising a two armed hinge, a connecting arm, and at least one sliding pivot, wherein the sliding pivot allows the connecting arm to move such that the axis about which the cartridge pivots open translates outside a plane as defined by the window frame.

21) A sliding hinge mechanism as claimed in claim 20 wherein the sliding hinge mechanism causes the cartridge to pivotally open to a position where the cartridge lies outside a projected three dimensional volume as defined by the internal, two dimensional area of the window frame.

22) A sliding hinge mechanism as claimed in claim 20 or claim 21 wherein opposite ends of the connecting arm are connected to different arms of the two armed hinge via sliding pivots.
